(19) United States
(12) Patent Application Publication
(10) Pub. No.: US 2013/0311940 A1
(43) Pub. Date: Nov. 21, 2013

(54) System of Organizing Digital Images

(71) Applicant: Salvadore V. Ragusa, Jefferson, LA (US)

(72) Inventor: Salvadore V. Ragusa, Jefferson, LA (US)

(21) Appl. No.: 13/472,212

(22) Filed: May 15, 2012

(51) Int. Cl. G06F 3/048

(52) U.S. Cl. 715/798

(57) ABSTRACT

A photography system uses electronically-readable software to process graphic objects that have been captured by a digital camera or scanned to an electronically-readable format for display on a square display screen. The images can be organized according to the aspect ratio, chronologically or according to other criteria selected by a user. The system operates to organize the displayed images in inform rows and/or columns on the page of the display screen.

### BACKGROUND OF THE INVENTION

The present invention relates to a system for creating, editing, and displaying digital photographs and similar electronically created images. More specifically, the present invention relates to a system, which allows a photographer to upload and display photographs in a digital photo album.

Digital photography has largely replaced the chemical-based labor-intensive processes of conventional photography. The advantage of digital over conventional photography are too numerous to mention, but suffice it to say that one entire industry has nearly disappeared only to be replaced by the other.

Photographs taken by digital methods can be displaced on computers, cameras, laptops, cell phones, etc. To capture these photos for safekeeping, the photographer can have the digital images printed and/or saved to a disk or memory card. The photographer can also upload images to digital photo albums. From camera to computer, video displays are now the most prevalent viewing method, with printed photos running a distant second.

For all of the advantages the digital photography offers, the final presentation of images on video displays leaves something to be desired even though it has nothing to do with the quality of current displays. Even the screen of a smart phone is capable of rending stunning images, while computer monitors and tablets offer larger and even higher quality images. The problem is that these devices all share a common flaw: their rectangular shape, which makes the ability to view a series of still photographs seem more like an afterthought, a last minute feature added to a video display.

The problem is most evident when photos are viewed on television and computer monitors because, in addition to being rectangular, their physical orientation is fixed in the horizontal/landscape position. This means that when a person views a vertical/portrait photo, it must be compressed by 50% to fit within the short side (height) of the screen. On the other hand, when a user displays a horizontal/landscape image on the horizontal/landscape positioned screen, the image fills 100% of the screen. When one considers a slideshow where some images fill the entire screen, while other images are half-sized the problem becomes apparent. The situation is better with tablets, digital photo frames or smart phones. They are portable and can be easily rotated to match their orientation to the image but require many steps while viewing a slideshow.

Despite all of the advances that have been made in video displays, the problem of inconsistent image sizing has not been addressed. The present invention contemplates elimination of drawbacks associated with conventional photography systems and provision of a system that maintains equal image size of a photograph regardless of orientation.

### SUMMARY OF THE INVENTION

It is, therefore, an object of the present invention to provide a photography system, which allows to display images in an equal size format regardless of the uploaded image orientation.

It is another object of the invention to provide a digital photo album that allows display of portrait and landscape images filling the entire screen all the time without the need to physically rotate the device.

These and other objects of the invention are achieved through a provision of photography system employing a display device having a square configuration screen. The square screen provides the additional space required for still photographs to rotate without altering their size. The transition between images on a square screen offers a more natural viewing experience because the image size remains constant regardless of the display orientation. Additionally, the square format is capable of displaying multiple image aspect ratios, notably 3:2 and 4:3, the two most commonly used in digital still photography.

The photography system of this invention uses electronically-readable software to process graphic objects that have been captured by a digital camera or scanned to an electronically-readable format for display on a square display screen. The images can be organized according to the aspect ratio, chronologically or according to other criteria selected by a user. The system operates to organize the displayed images in inform rows and/or columns on the page of the display screen.

### BRIEF DESCRIPTION OF THE DRAWINGS

Reference will now be made to the drawings, wherein like parts are designated by like numerals, and wherein

FIG. 1A illustrates a photograph taken in landscape (horizontal) format and displayed on a horizontal screen using a conventional system.

FIG. 1B illustrates a photograph taken in portrait (vertical) format and displayed on a horizontal screen using a conventional system.

FIG. 2A illustrates a photograph taken in landscape (horizontal) format and displayed on a vertical screen using a conventional system.

FIG. 2B illustrates a photograph taken in portrait (vertical) format and displayed on a vertical screen using a conventional system.

FIG. 3A illustrates a photograph taken in landscape (horizontal) format and displayed on a square screen using the system of the present invention.

FIG. 3B illustrates a photograph taken in portrait (vertical) format and displayed on a square screen using the system of the present invention.

FIG. 4 is a schematic representation of a full-screen vertical image with aspect ratio 3:2 using the system of this invention.

FIG. 5 is a schematic representation of a full-screen horizontal image with aspect ratio 3:2 using the system of this invention.

FIG. 6 is a schematic representation of a full-screen vertical image with aspect ratio 4:3 using the system of this invention.

FIG. 7 is a schematic representation of a full-screen horizontal image with aspect ratio 4:3 using the system of this invention.

FIG. 8 depicts a photo layout in four-image mode of both vertical and horizontal images with aspect ratio 3:2 using the system of this invention.

FIG. 9 depicts a photo layout in four-image mode of both vertical and horizontal images with aspect ratio 4:3 using the system of this invention.

FIG. 10 depicts a photo layout of thumbnail images of both vertical and horizontal images with aspect ratio 3:2 using the system of this invention.

FIG. 11 depicts a photo layout of thumbnail images of both vertical and horizontal images with aspect ratio 4:3 using the system of this invention.

FIG. 12 schematically illustrates the major hardware components of the system of the present invention.

### DETAIL DESCRIPTION OF THE INVENTION

The first task in the implementation of the system of the present invention is to capture images that will be organized, processed, and displayed on an electronic device, such as for instance a digital photo frame. The system of the present invention does not deal with the image capture stage, which can be performed using any conventionally available electronic digital camera 10. The system of the present invention can be also used for processing, organizing and displaying non-digitally captured images that have been scanned and converted to an electronic image format.

The system of the present invention begins at a step, where images captured or acquired by electronic digital means are uploaded onto an interface device 12 that will be used to organize, manipulate, and process the images. The system of the present invention also allows digital images to be acquired from various different sources, not necessarily digital cameras, such as CD-ROMS, memory sticks, flash drives, and other suitable means.

The image processing portion of the system of the present invention provides a number of tools for organizing the acquired images. The software for the image processing is stored on a disk 15 and can be downloaded into the interface device 12 or directly to a digital photo frame 14 if the photo frame 14 has sufficient memory. Alternatively, the interface device 12 can be serially connected between the camera 10 and the digital photo frame 14 using standard connectors, cables, etc. In that case, the software can be downloaded to the digital photo frame 14. The software stored on the disk 15 provides for user-implemented steps that can be displayed on the screen 16 and operated through a user interface.

Conventional digital photo frames have rectangular displays of a pre-determined aspect ratio. Aspect ratio is the fractional relationship between the width and height of an image. The two most common aspect ratios for digital photo frames are 4:3 (also known as 4×3, 1.33:1, or standard) and 16:9 (16×9, 1.78:1, or widescreen). Some frames have the ability to display images in 4:3 or 16:9. Some frames offer “panoramic” viewing (generally considered to be 3:1 aspect ratio), though this format is somewhat of a rarity for most manufacturers.

Most pictures photographers take are probably 4:3 and 3:2 aspect ratio. If a frame only displays 16:9, the 4:3 pictures will either be cropped or stretched. Several other problems are encountered when trying to accommodate both landscape and portrait photos for display in a rectangular photo frame. Even though a photo frame should be able to display both horizontal and vertical images with equal native format, the images are often compressed or extended in the aspect ratio of the normative format. Many of these techniques involve projecting the normative image in its original format onto the native display and simply blackening the “gaps” where no image information exists.

Letterboxing is the practice of transferring wider photo formats to more square formats while preserving the original aspect ratio. The resulting video display must include masked-off areas above and below the picture area, often referred to as black bars, or mattes. An example of letterboxing is shown in FIG. 2A, where the native landscape image of FIG. 1A is displayed on a vertical screen.

In contrast, pillarboxing is necessitated when a photo that was not originally designed for widescreen is shown on a widescreen display. An example of the image distortion is shown in FIG. 1B, where the vertical photo of FIG. 2B is displayed on a horizontal screen of FIG. 1B. The original material is shrunk and placed in the middle of the widescreen frame while vertical black bars are placed on either side of the image. Lastly, there are sometimes instances in which standard ratio images are presented in the central portion of a letterboxed picture, resulting in a black border all around. This effect is referred to as matchboxing, and obviously wastes a great deal of screen space as well as reduces the resolution of the original image.

The present invention solves these problems by providing a system that utilizes a square display of a digital photo frame and software that processes photo images of various aspect ratios and orientation to fit within the square screen while utilizing maximum screen space.

The digital photo frame 14 is provided with a square screen 16, on which the processed images are displayed. The system allows the interface device 12 and/or the digital photo frame 14 to “know” the format and aspect ratio of the incoming signal it is receiving from the camera 10 and/or interface device 12 before the images are displayed on the screen 16. The processing software determines the nature of the image content that is, whether the image is landscape or portrait, and the aspect ratio of the image and converts the images for displaying on the square screen 16 as if all images have 1:1 aspect ratios.

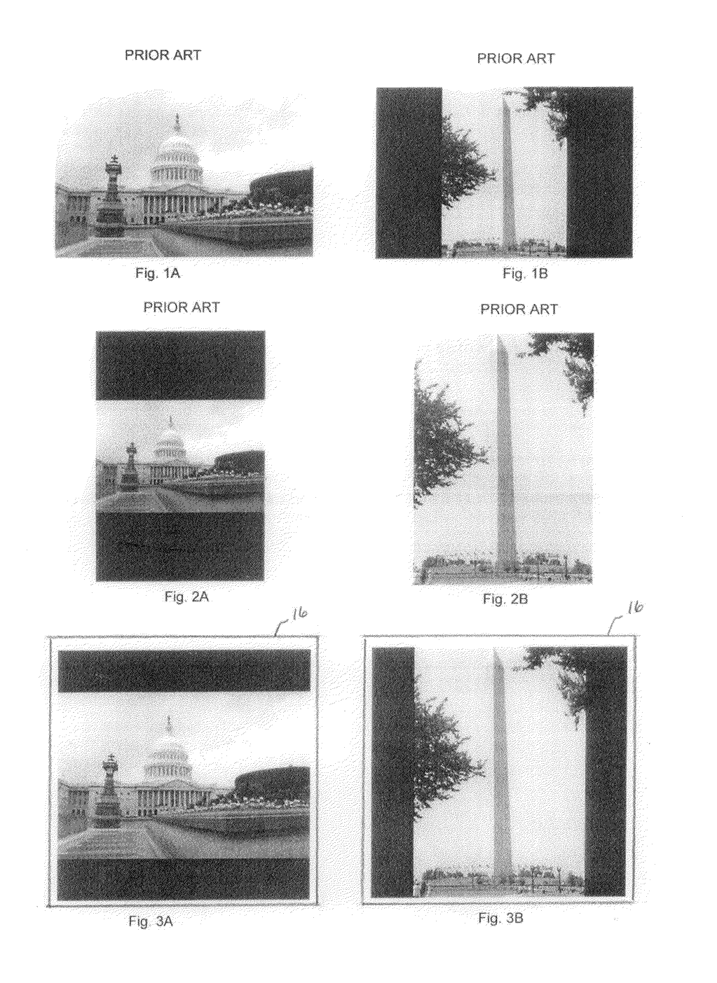

In the case where a given display is letterboxed, pillarboxed, or both, the soft ware also determines which portions of the image frame are real that is display an image and not the mattes such that appropriate and efficient image processing is accomplished. If the original image has an aspect ratio different than 4:3 or 3:2, fill, such as black space, is preferably added to “letterbox” the sides or the top and bottom of the image to retain the original proportionality of the image area. An example of a screen showing such black space imposed on a horizontal image is shown in FIG. 3A and an example of vertical pillarbox mattes is shown in FIG. 3B. In one aspect of the invention, the original image file is not modified or overwritten during this process.

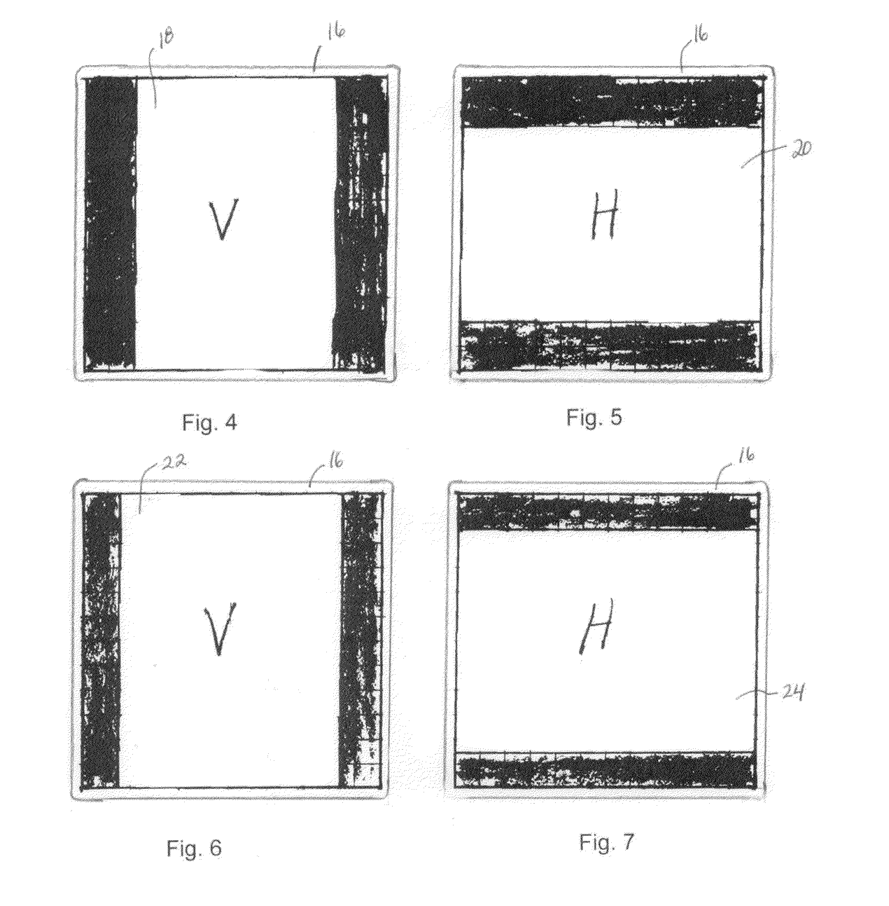

The digital photo frame of the present invention can be used to view single images, such as for instance shown in FIGS. 4 and 5, where aspect ratio of the original photos is 3:2. Image size is 8×12″, and an exemplary size of the screen is 12×12″. In the drawings, the letter “V” is used to designate vertical (portrait) images and the letter “H” is used to designate landscape (horizontal images). In this example, pillarbox mattes are formed on the sides of a vertical image 18, and letterbox mattes are formed on top and bottom of a horizontal image 20. Both images 18 and 20 are displayed on the screen 16 in their native format.

FIGS. 6 and 7 illustrate display of a single 9×12″ image with aspect ratio 4:3 on 12×12″ screen 16. Similarly to FIG. 4, two pillarbox mattes are formed on both sides of the image 22, while in FIG. 7 two top and bottom letterbox mattes are formed for the image 24.

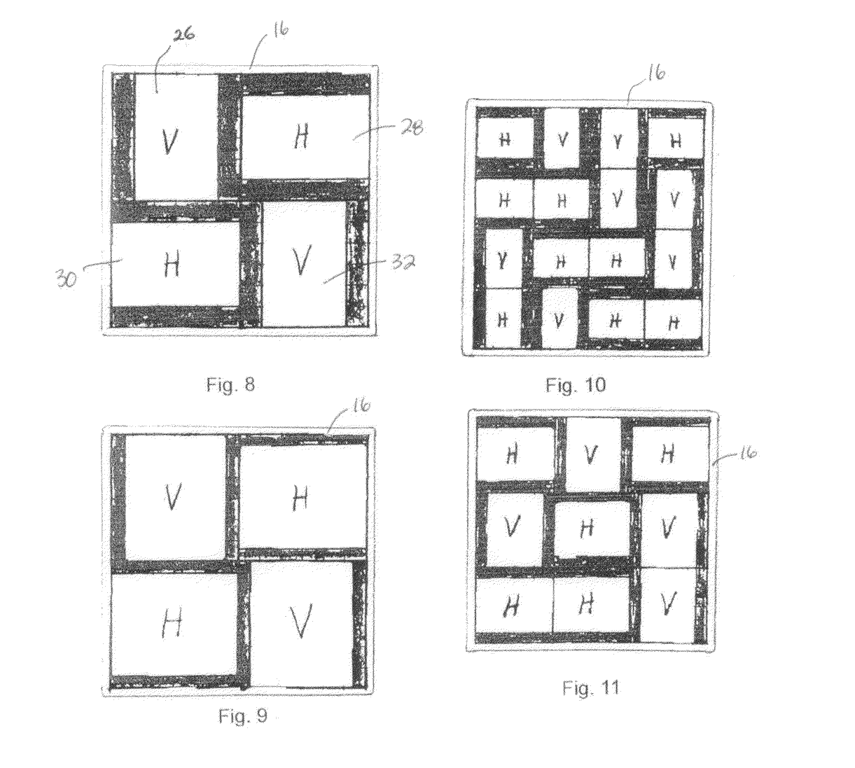

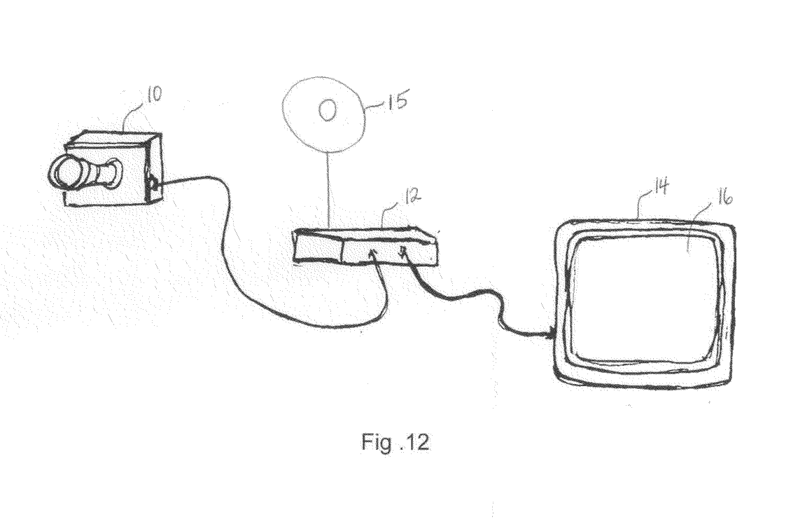

FIG. 8 illustrates display of a four 4×6″ images with aspect ratio 3:2 on 12×12″ screen 16. In this example, a vertical image 26 is rotated and fitted side-by-side to a horizontal image 28 in the upper row, and a reverse combination of horizontal to vertical images 30, 32 fills the bottom part of the screen 16. FIG. 9 illustrates display of a four 4.5×6″ images with aspect ratio 4:3 on 12×12″ screen 16. The four images are fitted on a square display filling substantially entire screen 16.

FIG. 10 illustrates display of multiple thumbnail images with original images being 3×2″, aspect ratio of 3:2 on 12×12″ screen 16. Similarly to other images described above, the images in FIG. 10 are processed, rotated and provided with pillarbox or letterbox mattes in order to utilize the entire viewable area of the screen 16. FIG. 11 illustrates display of nine (three per row and per column) images with original images being 4×3″, aspect ratio of 4:3 on 12×12″ screen. Even though the native format of the images is different, the system of the present invention allows processing and displaying of these images in variations of vertical and horizontal images within one row and one column such that a combination of the images substantially utilizes the entire viewing are of the screen 16.

It should be noted that image rotation is often desirable for certain images, such as those captured with the camera held in the vertical/portrait orientation. The invention utilizes an automatic image rotation algorithm that fits the rotated image entirely within the viewable area of the frame screen 16 or a designated area within a row and column of the screen. It also provides letterboxing and pillarboxing or addition of black space, to the sides, tops and bottoms of the rotated image. The captured photo images are displayed in a format more consistent with the square display.

The images displayed on the screen 16 are not compromised based on the screen orientation. It is envisioned that larger square screens can be used for various displays or incorporated into current digital photo frame designs to provide an improved visual presentation. The square-formatted screen solves the problem of screen resolution, brightness, color accuracy and other technical requirements by providing a more uniform and coherent photo viewing experience. It is a particular advantage of the invention that it provides for generating consistent image size regardless of the orientation, either vertical or horizontal and display thereof on a frame screen.

When the user is presented with a user interface on the screen 16, the program requests the user to select the desired layout of captured images to be displayed simultaneously on the screen, be it one image or a plurality of images arranged in rows and columns. The system determines the most efficient way of organizing the images on the screen corresponding to a page of a photo album. The system defines the respective size dimensions and position of the vertical and horizontal images on one “page.” When necessary, the system rotates the images and adds mattes to specific images so that consistent uniform image sizes are displayed on one page within a given row and column.

The system automatically determines the aspect ratio of the photo images and selects matching photo images to be displayed on a particular page. In one aspect of the invention, the user interface allows the user to identify and select the photo images corresponding to a particular matching aspect ratio to be displayed on a given page.

In one aspect of the invention, the image processing system provides various predefined layout templates that a user may select to create a digital photo album. The user can select images from the collection of the captured images to various predefined image locations on a selected layout template compatible with the square screen. The system will then automatically adjust the size, placement, rotation, and framing of the images in accordance with parameters specified for the various predefined image locations on the selected template. In another aspect of the invention, the system is designed to arrange the images in chronological order.

It is envisioned that the photography system of the present invention could be equipped, but not required to, with the following items: memory card reader, wi-fi capability, USB connectivity, internal memory, touch-screen operation, AC/DC compatibility and album/screen cover.

Many changes and modifications can be made in the system of the present invention without departing from the spirit thereof I, therefore, pray that my rights to the present invention be limited only by the scope of the appended claims.

I claim:

1. A method performed by a physical system comprising a digital photo display and an associated computer program executing device, the method comprising:
on the display, presenting a user interface responsive to user input requesting a layout of photographic images on a page of the digital photo display;
requesting the user to select a desired layout of captured photo images to be displayed simultaneously on the page of the digital photo display;
organizing the photo images on the page, while defining the respective size dimensions and position of the vertical and/or horizontal photo images on the page; and
on the page of the digital photo display, displaying the organized photo images.

2. The method of claim 1, wherein the digital photo display comprises a square display screen.

3. The method of claim 1, further comprising a step of automatically determining aspect ratio of the photo images and selecting photo images having matching aspect ratio to be displayed on a specific page.

4. The method of claim 3, comprising a step of presenting a user interface responsive to the user input requesting the user to select the photo images corresponding to the determined aspect ratio for displaying on the page.

5. The method of claim 1, comprising a step of organizing the photo images in rows and columns to be displayed on a specific page irrespective of photo images being captured in horizontal or vertical formats.

6. A machine readable medium for arranging graphic objects on a page, the machine readable medium storing machine-readable instructions causing a machine to perform operations comprising:
on the page of a digital display, presenting a user interface responsive to user input requesting a layout of graphic objects on the page of the digital display;
requesting the user to select a desired layout of graphic objects to be displayed simultaneously on the page of the digital display;
organizing the graphic objects on the page, while defining the respective size dimensions and position of the vertical and/or horizontal graphic objects on the page of the digital display; and
on the page of the digital display, displaying the organized graphic objects.

7. The machine readable medium of claim 6, wherein the machine readable instructions cause the machine to automatically determine aspect ratio of the graphic objects and select graphic objects having matching aspect ratio to be displayed on a specific page of the digital display.

8. The machine readable medium of claim 6, wherein the machine readable instructions cause the machine to present a user interface responsive to the user input requesting the user to select the graphic objects corresponding to the determined aspect ratio for displaying on the page of the digital display.

9. The machine readable medium of claim 6, wherein the machine readable instructions cause the machine to organize the graphic objects in rows and columns to be displayed on a specific page irrespective of graphic objects being captured in horizontal or vertical formats.

10. At least one computer-readable medium having electronically-readable program code embodied therein, the electronically-readable program code adapted to be executed by an electronic device to implement a method comprising:
on a display of an electronic device, presenting a user interface responsive to user input requesting a layout of photographic images on a page of the digital photo display;
requesting the user to select a desired layout of captured photo images to be displayed simultaneously on the page of the digital photo display;
determining aspect ratio of the photo images and selecting photo images having matching aspect ratio to be displayed on a specific page
organizing the photo images on the page, while defining the respective size dimensions and position of the vertical and/or horizontal photo images on the page; and
on the page of the digital photo display, rendering the organized photo images layout in the user interface.

11. The at least one computer-readable medium of claim 10, comprising a program code adapted to be executed by an electronic device to implement a step comprising: organizing the photo images in uniform rows and columns to be displayed on a specific page irrespective of photo images being captured in horizontal or vertical formats.

12. A photography system, comprising: digital photo display, a memory storing electronically-readable instructions, a data processing unit coupled to the memory, operable to execute the instructions, and based at least in part on the execution of the instructions operable to perform operations comprising the steps:
on a display of an electronic device, presenting a user interface responsive to user input requesting a layout of photographic images on a page of the digital photo display;
requesting the user to select a desired layout of captured photo images to be displayed simultaneously on the page of the digital photo display;
determining aspect ratio of the photo images and selecting photo images having matching aspect ratio to be displayed on a specific page organizing the photo images on the page, while defining the respective size dimensions and position of the vertical and/or horizontal photo images on the page; and
on the page of the digital photo display, rendering the organized photo images layout in the user interface.

13. The system of claim 12, wherein the digital photo display comprises a square image display.

14. The system of claim 12, operable to execute the instructions operable to perform operations comprising the steps: automatically determining aspect ratio of the photo images and selecting photo images having matching aspect ratio to be displayed on a specific page.

15. The system of claim 12, operable to execute the instructions operable to perform operations comprising the steps: presenting a user interface responsive to the user input requesting the user to select the photo images corresponding to the determined aspect ratio for displaying on the page.

16. The system of claim 12, operable to execute the instructions operable to perform operations comprising the steps: comprising a step of organizing the photo images in uniform rows and columns to be displayed on a specific page irrespective of photo images being captured in horizontal or vertical formats.
